(19) United States
(12) Patent Application Publication
(10) Pub. No.: US 2003/0050875 A1
(43) Pub. Date: Mar. 13, 2003

(54) Method of sales deposit management

(75) Inventors: Yeun-Jonq Lee, Taipei (TW); Yueh-Wen Chen, Taipei (TW); Yi-Hui Lin, Taipei (TW)

Correspondence Address: DOUGHERTY& TROXELL, SUITE 1404, 5205 LEESBURG PIKE, FALLS CHURCH, VA, 22041, US

(73) Assignee: Via Technologies, Inc.

(21) Appl. No.: 10/101,418

(22) Filed: Mar. 20, 2002

(30) Foreign Application Priority Data
Aug. 29, 2001 (TW) 90121370

(51) Int. Cl. G06F 17/60

(52) U.S. Cl. 705/29

(57) ABSTRACT

The present invention is a method of sales deposit management. It is applied in a computer system and comprises the following steps. First, the data of the client's order is input to the computer system first. Then a new sales order record comprising a sales deposit record is produced based on the order information from the client. And a new sales deposit collection record is produced based on the sales deposit record and the details of client's deposit payment. Next a new record of sales deposit collection voucher and a new record of sales deposit invoice are produced based on the sales deposit collection record. A new delivery record as the reference for product delivery is produced based on the sales order record subsequently. And based on the delivery record and the sales deposit invoice record, a sales invoice record for the client is produced to complete the invoice-issuing process.

### FIELD OF THE INVENTION

The present invention relates to a method for application in Enterprise Resource Planning (ERP) system, and more specifically, a method of sales deposit management.

### BACKGROUND OF THE INVENTION

Sales deposit, also known as advance collection or advance revenue, is received by a business from its client before providing any commodities or services. A business which requires advance collection ahead will reach an agreement with its client to provide the commodities or services during a certain period after the client prepays agreed sales deposit.

The conventional ERP system does not record the details of sales deposit amounts or deposit payment terms while processing sales orders. When receiving a sales deposit from the client, the system cannot record which order the sales deposit matches. It also fails to recognize if there is an issued invoice for sales deposit after the business provides services or commodities; it can only create a general sales ledger for the transaction and issue an invoice with the total amount of services or commodities. In the process of ledger cancellation after receiving the accounts receivable from the client, the conventional ERP system, however, can only list the amount of accounts receivable in the original sales ledger; the user still has to retrieve the original voucher entry of advance collection to offset the rest accounts receivable and complete the cancellation process.

The following example shows the complete process of payment collection for a sales order and ledger cancellation. (Please refer to FIG. 1):

FIG. 1 shows the typical flow of processing a sales order comprising receiving an order, receiving a deposit, delivering products, issuing an invoice, creating a sales ledger, collecting payment, and canceling out (offsetting; converting) a ledger.

Receiving an order: The conventional ERP system collects and transfers all the order information including sales deposit details into the sales order record 102.

Receiving a deposit: The conventional ERP system does not have a deposit-processing function. It requires the business—mostly by its accounts or financial staff—to manually create a sales deposit collection record 108 based on the details of deposit payment from the client (such as: paid by cash/remittance/check) and accordingly to create a record of sales deposit collection voucher 110. The sales deposit collection voucher 110 lists the prepaid amount and deposit payment details (such as: paid by cash/remittance/check) shown in the sales deposit collection record 108. Note: the system can neither issue a deposit invoice to the client nor assign the deposit to its appropriate sales order. The entry for the sales deposit collection voucher 110 is as follows (the amounts are assumption values):

| | | |
|---|---|---|
| Debit: | Cash | 100 |
| Credit: | Advance collection | 100 |
| | (or Temporary Collection) | |

Delivering products: The conventional ERP system, based on the sales order record 102, produces a delivery record 114 and delivers products accordingly. Note: the conventional ERP system cannot check out if the client has paid the sales deposit when making a delivery list.

Issuing an invoice: Based on the delivery record 114, the conventional ERP system produces a sales invoice record 116 for the client. Note: the amount in the sales invoice record 116 is the total delivery amount without deducting the prepaid deposit. This is because the conventional ERP system does not link the sales deposit collection record 108, the sales deposit invoice record and the sales order record 102. When printing the sales invoice record 116, the system cannot consider if a sales deposit invoice has been issued; therefore, it can only issue a sales invoice based on the total delivery amount.

Creating a sales ledger: Based on the sales invoice record 116, the conventional ERP system creates a sales ledger voucher record (or the sales revenue voucher record) 118. Note: the amount in the sales ledger must pertain to the delivery amount, so the entry for accounts receivable in the sales ledger voucher record 118 is equivalent to the delivery amount in the sales invoice record 116 (tax included). The following example shows an entry in the sales ledger voucher record 118 (the amounts are assumption values):

| | | |
|---|---|---|
| Debit: | Accounts receivable | 1,050 |
| Credit: | Sales Revenue | 1,000 |
| Credit: | Sales Tax | 50 |

Collecting payment from the client: Based on the client's payment details (such as paid by cash/remittance/check), the conventional ERP system produces a payment collection record 120. Note: the payment collection record 120 comprises the paid amount and the above payment details. The collected amount should be less than the total delivery amount while the client has prepaid a deposit.

Canceling out the ledger: The business has to manually retrieve the sales ledger voucher record 118 and the sales deposit collection voucher record 110. Based on the payment collection record 120, the sales ledger voucher record 118, and the sales deposit collection voucher record 110, an accounts receivable to cancel out the sales ledger voucher 122 is produced. Note: The conventional ERP system can only process the offset of the accounts receivable (or the total delivery amount) against the amount in the payment collection record 120. The business still has to review the sales deposit collection voucher record 110 and manually offset the accounts receivable in the sales ledger voucher record 118 against the amount in the sales deposit collection voucher record 110. The following example will further clarify the above description:

Based on the sales ledger voucher record 118 and the payment collection record 120, the business creates a voucher entry as follows (the amounts are assumption values), and then cancels out the accounts receivable in the sales ledger voucher record 118 with the accounts receivable in the following voucher entry:

| | | |
|---|---|---|
| Debit: | Cash | 950 |
| Credit: | Accounts Receivable | 950 |

Based on the manually retrieved sales deposit collection voucher record 110, the business creates a voucher entry as follows (the amounts are assumption values), and then cancels out the accounts receivable in the sales ledger voucher record 118 with the accounts receivable in the following voucher entry:

| | | |
|---|---|---|
| Debit: | Advance collection | 100 |
| | (or Temporary Payment) | |
| Credit: | Accounts Receivable | 100 |

This example demonstrates the importance of having a better ERP system that can effectively improve the sales deposit management.

### SUMMARY OF THE INVENTION

A provided method for sales deposit management based on one embodiment of the present invention comprises at least the following steps:

Enter the information of the client's order comprising the varieties and quantities of the products into a computer system (such as a sales management system). Based on the order, the computer system produces a sales order record comprising the sales deposit record that covers the sales deposit payment terms. Based on the sales deposit record and the deposit payment details, the computer system produces a sales deposit collection record that can locate the correlated sales order(s) for the specific deposit payment. Then, based on the sales deposit collection record, the computer system produces a sales deposit collection voucher record and a sales deposit invoice record, wherein the sales deposit invoice record is ready for the client to complete the process of issuing deposit invoices. However, if an invoice is not required until delivery, there is no need to create a sales deposit record now.

Next, a delivery record based on the sales order record is produced by the computer system for delivery reference. Based on the delivery record and the sales deposit invoice record, the computer system produces a sales invoice for the client to complete the invoice-drawing process. The amount in the sales invoice relates to the payment amount in the delivery record, the amount in the sales deposit invoice record, and the method to convert the deposit into sales revenue. However, if a deposit invoice is not required, a sales invoice carrying the same amount of the total delivery payment will be issued at delivery.

The above-mentioned order information further includes product delivery date. The sales order record comprises client's invoice number, client title, product name, product unit price, purchasing quantity, and delivery date. The sales deposit record comprises sales order number, deposit amount, deposit payment deadline, the method to offset deposit against sales revenue, and whether to issue an invoice when receiving a sales deposit. The sales deposit collection record comprises client invoice number, payment method, date for deposit payment, deposit amount, whether to issue a deposit invoice, invoice type, tax bracket, and tax rate.

The conversion of deposit into sales revenue includes cancellations based on the proportion of each delivery amount or an all-in-one cancellation after all the deliveries. After producing the delivery record, this computer system refers to the sales deposit payment terms and automatically checks if the client has paid the sales deposit before approving delivery. After producing the sales invoice record, this computer system further produces a sales ledger voucher record based on the sales invoice record, the sales deposit invoice record and the sales deposit collection voucher record to complete the process of creating a sales ledger. This sales ledger voucher record comprises voucher date, account terms for the debit and credit sides in the voucher entry, and amounts for the debit and credit sides. The accounts receivable in the debit side equals to the product of the deposit conversion at delivery proportion and the difference of the total delivery amount & the deposit amount in the sales deposit invoice record.

After producing a sales ledger voucher record, this computer system further produces a payment collection record based on the payment collected from the client to complete the collection process. The payment collection record includes client invoice number, payment method, collection date, and collected amount. After producing the payment collection record, this computer system further connects the payment collection record and the sales ledger voucher record to produce an accounts receivable record by offsetting the accounts receivable in the sales ledger voucher record against the collected amount in the payment collection record.

### BRIEF DESCRIPTION OF THE DRAWINGS

FIG. 1 is a flow chart for processing sales orders in accordance with the prior art;

FIG. 2 illustrates the sales record maintenance function on the screen provided by the sales deposit management method in accordance with an embodiment of the present invention;

FIG. 3 & FIG. 4: both illustrate the function to record advance collection and to create an automatic ledger on the screen provided by the sales deposit management method in accordance with an embodiment of the present invention; and

FIG. 5 illustrates the flow chart for processing sales orders by the sales deposit management method in accordance with an embodiment of the present invention.

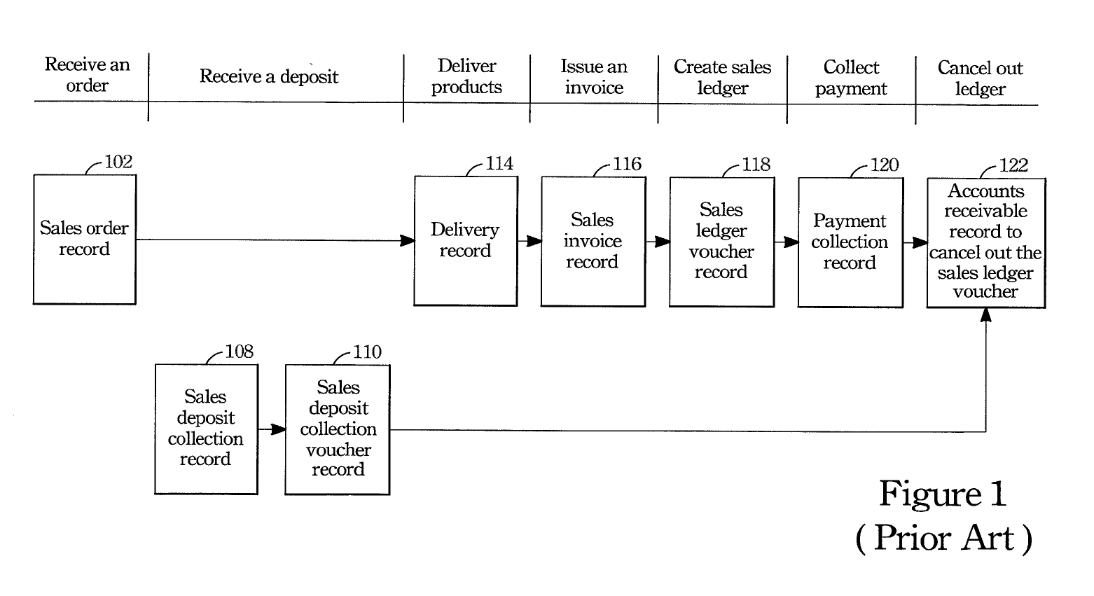

### DETAILED DESCRIPTION OF THE INVENTION

The main purpose of the present invention is to provide a sales deposit management method as the resolution for the conventional ERP system in managing sales deposit.

The uniqueness of the present invention is to provide an improved management mechanism for sales deposit transactions from recording the deposit information of the sales order, collecting sales deposit, creating a sales deposit ledger, issuing a sales invoice, to the automatic cancellation of deposit as sales revenue. The improved mechanism simplifies the process flow and saves manpower.

One embodiment for the sales deposit management mechanism of the present invention is detailed in three sections as follows—A) the process of from receiving a sales order to receiving a sales deposit B) the process of sales deposit collection, and C) the conversion of sales deposit into sales revenue.

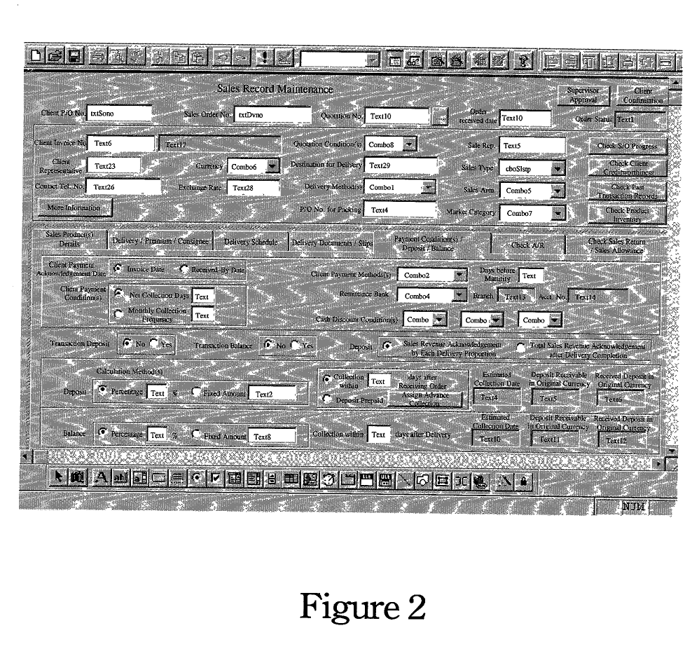

A. Sales order—sales deposit: the present invention provides “Sales Record Maintenance” function on the screen to maintain all the sales records (please refer to FIG. 2). The user enters related deposit details from each single sales order requiring advance collection before a deadline. The said deposit details encompass the calculation of deposit by each delivery proportion of the total sales amount or by a fixed amount, the estimated date for deposit collection, and the cancellation of deposit as sales revenue either by each delivery proportion in the sales order or through a complete offset after finishing deliveries.

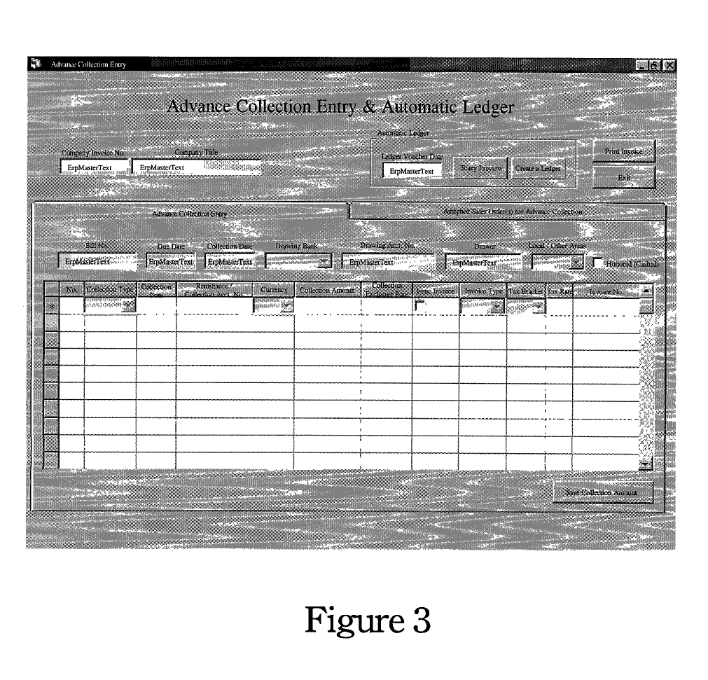

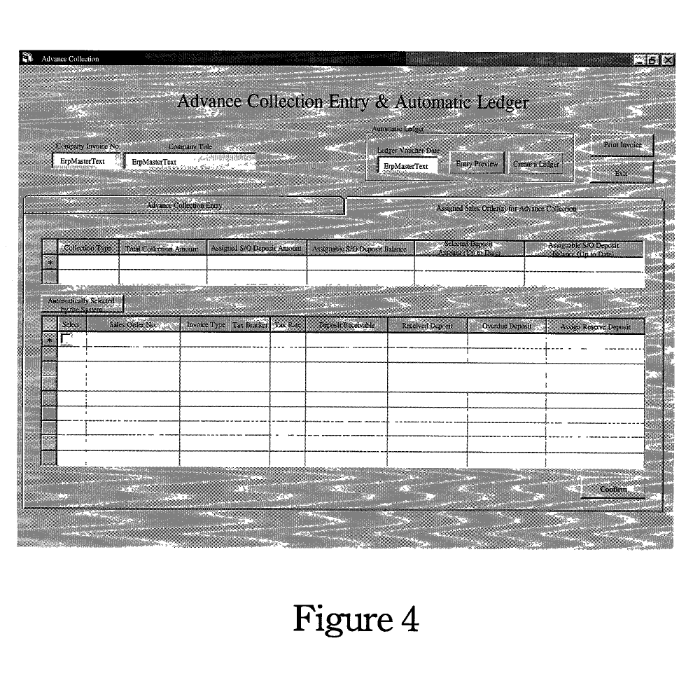

B. Sales deposit collection: The present invention provides a function to record advance collection and to create an automatic ledger via “Advance Collection entry & Automatic Ledger” showing on the monitor screen (as shown in FIG. 3 & 4). After receiving a sales deposit payment from the client, the user can access to “Advance collection entry & Automatic Ledger” (as shown in FIG. 3 & 4) to specify the correlated sales order(s) and enter payment collection details.

The present invention also provides a function for the user to issue and print invoices. In the function of “Advance Collection & Automatic Ledger” on the screen, the user can choose to issue an invoice for an advance collection and further select issuing method, invoice type, tax bracket, and tax rate. After pressing “Print Invoice” button, the system starts printing an invoice and shows the invoice number on the screen. The present invention further reads and shows on the screen the account terms in the ledger set by the user for deposits with or without an invoice. The user can press “Entry Preview” button to view the payment entry or press “Create a Ledger” button to process advance collection/temporary collection.

With the present invention, the user can pertain to the sales order for tracking its sales deposit payment or even monitor the deposit payment status for processing the delivery.

C. Conversion of Sales Deposit into Sales Revenue: When printing a sales invoice at delivery, the present invention automatically specifies if the client has prepaid the deposit and if an invoice for the collected deposit has been issued. Without an issued deposit invoice (as in the following situation 3 & 4), the amount in the sales invoice equals to the amount for delivery. With an issued deposit invoice whose amount has been offset against sales revenue based on the delivery proportion (as in the following situation 2), the sales invoice amount equals to the product of the difference of the delivery amount & the invoice-issued deposit amount and the proportion of delivery amount in the total sales amount.

The present invention produces different voucher entries in the sales ledger. It puts into consideration if the sales deposit has been received, if an invoice has been issued, if the deposit has been canceled out as sales revenue or would be canceled out after finishing all the deliveries. Four different situations are further demonstrated as follows:

Example: Company A sells some products for $1,000 (before tax). The tax rate is 5%. The deposit is $100 (before tax) with the payment deadline on January 10. There are two deliveries for this order: 20% before February 10; 80% before March 10.

Situation 1: A deposit invoice is issued- the complete cancellation
of deposit as sales revenue comes after finishing the deliveries.

| 1/10 | Receive deposit $105; the ledger entry as follows: | |
|---|---|---|
| | Debit: Cash | 105 |
| | Credit: Advance collection | 100 |
| | Credit: Sales Tax | 5 |
| 2/10 | 20% Delivery; the ledger entry as follows: | |
| | Debit: Accounts receivable | 210 |
| | Credit: Sales Revenue | 200 |
| | Credit: Sales Tax | 10 |
| 3/10 | 80% Delivery; the ledger entry as follows: | |
| | Debit: Accounts receivable | 735 |
| | <Note: 1,050 × 0.8 − 105 = 735> | |
| | Credit: Sales Revenue | 700 |
| | Credit: Sales Tax | 35 |
| | Debit: Advance collection | 100 |
| | Credit: Sales Revenue | 100 |

Situation 2: A deposit invoice is issued- the cancellation of deposit
as sales revenue is based on the delivery amount proportion.

| 1/10 | Receive deposit $105; the ledger entry as follows: | |
|---|---|---|
| | Debit: Cash | 105 |
| | Credit: Advance collection | 100 |
| | Credit: Sales Tax | 5 |
| 2/10 | 20% Delivery; the ledger entry as follows: | |
| | Debit: Accounts receivable | 189 |
| | <Note: (1,050 − 105) × 0.2 = 189> | |
| | Credit: Sales Revenue | 180 |
| | Credit: Sales Tax | 9 |
| | Debit: Advance Collection | 20 |
| | Credit: Sales Revenue | 20 |
| 3/10 | 80% Delivery; the ledger entry as follows: | |
| | Debit: Accounts receivable | 756 |
| | <Note: (1,050 − 105) × 0.8 = 756> | |
| | Credit: Sales Revenue | 720 |
| | Credit: Sales Tax | 36 |
| | Debit: Advance collection | 80 |
| | Credit: Sales Revenue | 80 |

Situation 3: A deposit invoice is not issued- the complete
cancellation of deposit as sales revenue comes
after finishing the deliveries.

| 1/10 | Receive deposit $100; the ledger entry as follows: | |
|---|---|---|
| | Debit: Cash | 100 |
| | Credit: Temporary Collection | 100 |
| 2/10 | 20% Delivery; the ledger entry as follows: | |
| | Debit: Accounts receivable | 210 |
| | Credit: Sales Revenue | 200 |
| | Credit: Sales tax | 10 |
| 3/10 | 80% Delivery; the ledger entry as follows: | |
| | Debit: Accounts receivable | 740 |
| | Debit: Temporary Collection | 100 |
| | Credit: Sales Revenue | 800 |
| | Credit: Sales tax | 40 |

Situation 4: A deposit invoice is not issued- the cancellation of
deposit as sales revenue is based on the delivery amount proportion.

| 1/10 | Receive deposit $100; the ledger entry as follows: | |
|---|---|---|
| | Debit: Cash | 100 |
| | Credit: Temporary Collection | 100 |
| 2/10 | 20% Delivery; the ledger entry as follows: | |
| | Debit: Accounts receivable | 190 |
| | Debit: Temporary Collection | 20 |
| | Credit: Sales Revenue | 200 |
| | Credit: Sales Tax | 10 |
| 3/10 | 80% Delivery; the ledger entry as follows: | |
| | Debit: Accounts receivable | 760 |
| | Debit: Temporary Collection | 80 |
| | Credit: Sales Revenue | 800 |
| | Credit: Sales Tax | 40 |

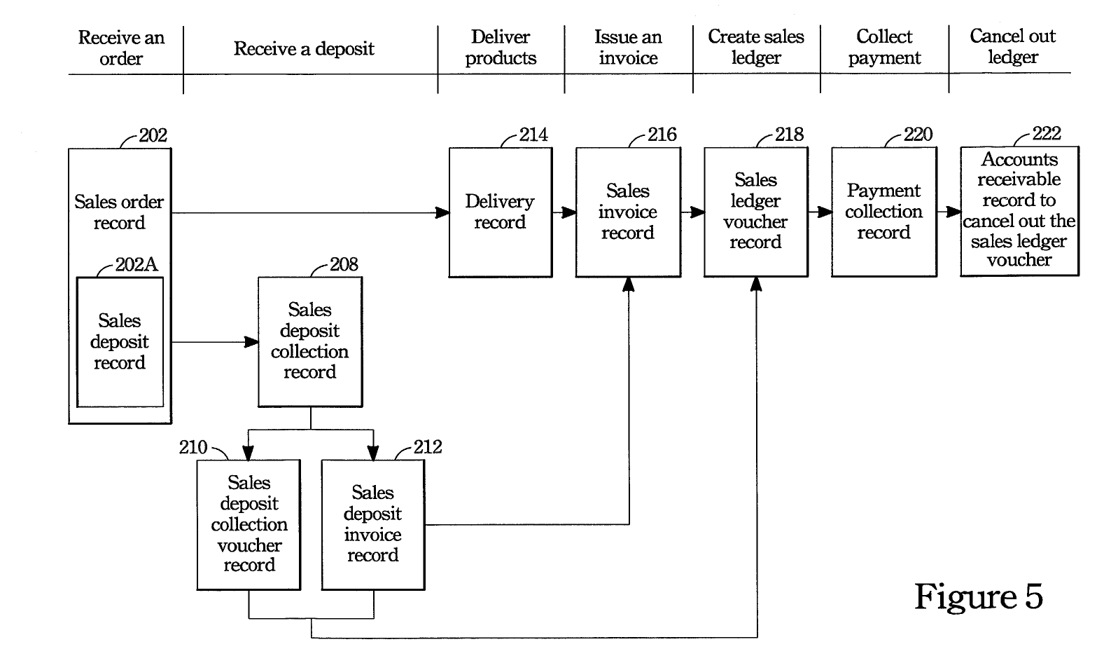

The sales deposit management method provided by the present invention can be applied to an ERP system. The following is a preferred embodiment demonstrating how the process from receiving an order to canceling out the ledger (please refer to FIG. 5) is completed with the application of the provided method in an ERP system. Furnished with the function of sales deposit management, the ERP system from the present invention could also be called the Sales Management system of the present invention:

As FIG. 5 shows, the sales order process of the present invention mainly comprises receiving an order, receiving a deposit, delivering, issuing an invoice, creating a sales ledger, collecting payment, and canceling out the ledger. The provided method applied during the above operation process is further detailed as follows:

Receiving an order: The ERP system of the present invention (the Sales Management system) collects the order information consisting of product, quantity, and delivery date from the sales people to produce a sales order record 202. This sales order record 202 comprises sales deposit record 202A and sales order information such as client invoice number, client title, product name, price per unit & quantity, and delivery date. The sales deposit record 202A includes sales order number and sales deposit payment terms for this order, such as deposit amount, payment deadline, conversion of deposit into sales revenue, and whether to issue an invoice when receiving a deposit.

The biggest difference in receiving an order between the present invention and the prior art is that the ERP system of the present invention can record the sales deposit payment terms of the sales order.

Receiving a deposit: the ERP system of the present invention creates a sales deposit collection record 208 based on the deposit payment details and the sales deposit record 202A included in the sales order record 202. The deposit payment record consists of payment amount, payment method (cash/remittance/check), and payment date. Based on the sales deposit collection record 208, a sales deposit collection voucher record 210 and a sales deposit invoice record 212 (if requested by the client) are created, wherein the sales deposit collection record 208 cross-checks the sales deposit record 202A.

The sales deposit collection record 208 comprises the sales deposit payment terms in the sales deposit record 202A and the deposit payment details such as client invoice number, payment method, collection date, collected amount, whether to issue an invoice & the invoice type, tax bracket, and tax rate. The sales deposit collection voucher record 210 comprises voucher date, account terms for the debit and credit sides in the voucher entry, amounts for the debit and credit sides. The sales deposit invoice record 212 comprises invoice-issued date (collection date), sales deposit amount, tax amount, invoice type, tax bracket, and tax rate.

The biggest difference in receiving deposits between the present invention and the prior art comes from that the ERP system of the present invention correlates sales order numbers and sales deposit amounts for cross-checking the received sales deposits and sales deposit payment terms in the sales orders.

Delivering: The ERP system of the present invention, based on the sales order record 202, produces a delivery record 214 as the delivery reference for the client. The delivery record 214 is comprised of departure date, warehouse address, product for delivery, quantity, estimated arrival date, and delivery destination.

Issuing an invoice: Based on the delivery record 214 and the sales deposit invoice record 212, the ERP system of the present invention produces a sales invoice 216 for the client. The sales invoice record 216 consists of invoice-issued date, product name, quantity, unit price, total amount, tax, invoice type, tax bracket, and tax rate. Note: the system pertains to the sales deposit invoice record 212 when calculating the amounts for sales and tax in the sales invoice record 216. Meanwhile, the ERP system of the present invention refers to the delivery record 214, whether the deposit invoice has been issued, whether the cancellation of deposit as sales revenue is based on each delivery proportion or is wholly completed after all the deliveries. For example: If it is an all-in-one delivery with an issued deposit invoice, then the amount in the sales invoice record 216 equals to the total delivery payment amount deducted by the deposit.

The biggest difference in issuing an invoice between the present invention and the prior art comes from that the present one automatically checks if the deposit invoice has been issued and deducts the invoice-issued sales deposit when calculating the net amount of the sales invoice.

Creating a sales ledger: Based on the sales invoice record 216, sales deposit collection voucher record 210 and the sales deposit invoice record 212, the ERP system produces a sales ledger voucher record (or a sales revenue voucher record) 218 which consists of voucher date, account terms for the debit and credit sides in the voucher entry, and amounts for the both sides. The account terms for the debit and credit sides and their amounts are related to the sales invoice record 216, the sales deposit collection voucher record 210, the sales deposit invoice record 212, and the conversion of deposit into sales revenue. The system, with its flexibility, automatically calculates and produces the correct sales ledger voucher record 218 in different situations.

The biggest difference in the sales ledger between the present invention and the prior art comes from that when creating a sales ledger record (Debit: Accounts receivable Credit: Sales Revenue), the ERP system of the present invention automatically puts into consideration the sales deposit invoice record 212, the sales deposit collection voucher record 210, the sales invoice record 216, and the conversion of deposit into sales revenue before producing a correct sales ledger voucher record 218. In other words, the system pertains to the sales deposit payment terms to convert the entry of advance collection or temporary collection in the sales deposit collection voucher record 210 into sales revenue. As for the entry of the sales ledger voucher record 218, the amount of accounts receivable in the debit side, not including the received deposit, should be the actual amount the client has not paid. When collected from the client, this payable amount needs to be recorded in the voucher, which equally offsets the accounts receivable in the sales ledger voucher record 218.

Payment Collection: Based on the received payment record consisting of payment amount, payment method (by cash/remittance/check), and payment date, the ERP system produces the payment collection record 220 to complete the collection process. This payment collection record 220 covers client invoice number, payment method, collection date, and collected amount.

Canceling out the ledger: Based on the payment collection 220 and the sales ledger voucher record 218, the ERP system of the present invention produces an accounts receivable record 222 to cancel out the sales ledger voucher. This record 222 comes from a produced voucher based on the payment collection record 220. The accounts receivable of the credit side in the voucher equally cancels out the accounts receivable in the debit side in the sales ledger voucher record 218. The above description is illustrated briefly as follows:

The system creates the following collection voucher record (the amounts are assumption values), which cancels out the accounts receivable of the debit side in the sales ledger voucher record 218 with the accounts receivable in its credit side:

| | | |
|---|---|---|
| Debit: | Cash | 950 |
| Credit: | Accounts | 950 |
| | receivable | |

Generally, the present invention provides a complete sales deposit management mechanism for real-world business transaction patterns in which the business receives payment before delivering services or commodities. For sales deposit collection, the present invention can choose to issue an invoice, to automatically print an invoice and create a sales deposit collection voucher. For delivery, the system automatically refers to the sales deposit payment terms in the sales order and checks if the client has paid the sales deposit before processing the delivery. For each partial delivery of the same order, the sales deposit can either be canceled out as sales revenue with the delivery proportion or cancelled out as a whole after all the deliveries. The uniqueness of the present invention, its superiority to the prior art, and the drawbacks it overcomes are described as follows:

(1) Trace the status of sales deposit payment: The present invention provides the user with the transaction terms of each sales order record that requires deposit payment, and accurately records the link between every advance collection and its correlated sales order. Thus, the system can refer to each sales order for providing the user with the deposit payable amount, received amount, and overdue amount to trace advance collection if necessary.

(2) Monitor the delivery process: The present invention automatically checks if the client has paid the sales deposit before processing delivery.

(3) Simplify the process of collecting sales deposit, issuing an invoice and creating a ledger: The present invention processes sales deposit collection on one screen, where the user can enter which order the client has paid a deposit for and its related collection information or flexibly choose whether to issue a deposit invoice under the company regulations or transaction terms. When the user presses “Print Invoice” button, the system immediately produces an invoice record and prints an invoice. For the sales deposit collection ledger, the user presses “Create a Ledger” after choosing account terms for the debit and credit sides, and then the system automatically produces a voucher that can be previewed to ensure the accuracy of the entry. Different from the prior art processing the three functions through three separate screens, the present invention simplifies the process of collecting sales deposit, issuing an invoice, and creating a collection ledger. It also keeps a detailed record of cross-checked information throughout the process.

(4) When issuing a sales invoice, the present invention automatically checks if a sales deposit invoice has been issued for the order and recalculates the net amount of the sales invoice to ensure it does not overlap the invoice-issued deposit amount. With the mechanism of the present invention, a system can automatically refer to the delivery amount in the sales order and the invoice-issued deposit amount before accurately calculating the net amount of the sales invoice. The user can save time in checking related documents, calculating invoice amounts by hand, or entering invoice details for printing invoices.

(5) Cancel out sales deposit as sales revenue automatically: During the process of creating a sales ledger, the present invention automatically checks if a specific sales deposit for the sales order has been received, searches the correlated account term (advance collection or temporary collection) for the sales deposit collection ledger, and converts it into sales revenue. Furthermore, the present invention can process simple transactions for an individual order, a deposit, and an all-in-one delivery, as well as complicated ones such as a sales order with many deposits and partial deliveries. Pertaining to details in the sales order, the present invention automatically converts received deposit into sales revenue according to each delivery proportion.

(6) The sales ledger of the present invention has deducted the sales deposit when calculating the accounts receivable amount, which turns out to be exactly what the client has not paid. It, therefore, shows more accuracy than the prior art. The sales deposit management of the present invention ensures that the user, after the transaction or payment collection, does not need to confirm whether there has been an advance collection from the client or to waste time collecting the original advance collection voucher record before processing the accounts receivable cancellation.

It is to be understood that while a certain preferred embodiment of the invention is illustrated, various changes or modifications may be made without departing from the scope of the invention and the invention is not to be considered limited to what is shown and described in the specification and drawings.

What is claimed:

1. A method of sales deposit management to be applied in a computer system, wherein said method comprises the steps of:
entering a client's order information comprising products and quantities ordered by said client into said computer system;
producing a sales order record comprising a sales deposit record and its sales deposit payment terms by said computer system based on said order information;
producing a sales deposit collection record by said computer system based on said sales deposit record and a record of received deposit payment from said client to specify which sales orders said client has paid said deposit for;
producing a sales deposit collection voucher record and a sales deposit invoice record by said computer system based on said sales deposit collection record, wherein said sales deposit invoice record is ready for the client;
producing a delivery record as the reference for delivery by said computer system based on said sales order record; and
producing a sales invoice record for the client by said computer system based on said delivery record and said sales deposit invoice record, wherein the invoiced amount relating to the payment amount of said delivery record, the amount in said sales deposit invoice record, and the conversion of said deposit into sales revenue.

2. The method of claim 1, wherein said order information further comprises product delivery date, said sales order record comprises client invoice number, client title, product name, product unit price & quantity, and delivery date, said sales deposit record comprises sales order number, deposit amount, deposit payment deadline, conversion of deposit into sales revenue, and whether to issue an invoice for a received deposit, said sales deposit collection record comprises client invoice number, payment method, deadline for deposit payment, deposit amount, whether to issue a deposit invoice or the invoice type, tax bracket, and tax rate, and said conversion of deposit into sales revenue comprises conversions based on each delivery proportion or a conversion of the total deposit into sales revenue after all the deliveries.

3. The method of claim 1, wherein after producing said delivery record, further comprises a step of checking automatically if said client has paid said sales deposit before processing delivery by said computer system according to said sales deposit payment terms.

4. The method of claim 1, wherein after producing said sales invoice record, further comprises a step of producing a sales ledger voucher record according to said sales invoice record, said deposit invoice record, and said sales deposit collection voucher record.

5. The method of claim 4, wherein said sales ledger voucher record comprises voucher date, account terms of the debit and credit sides, and amounts from both sides.

6. The method of claim 5, wherein said amount of the accounts receivable from said debit side is equivalent to the product of said deposit conversion proportion at delivery and the difference of the total delivery amount & the deposit amount in said sales deposit invoice record.

7. The method of claim 4, wherein after producing a sales ledger voucher record, further comprises a step of producing a payment collection record by said computer system based on said received payment record, said payment collection record comprising client invoice number, payment method, collection date, and collected amount.

8. The method of claim 7, wherein after producing a payment collection record, further comprises a step of producing an accounts receivable record to cancel out said sales ledger voucher record by said computer system based on said payment collection record and said sales ledger voucher record.

9. The method of claim 8, wherein said accounts receivable record means that said collected amount in said payment collection record canceling out said accounts receivable amount in said sales ledger voucher record.

10. A method of sales deposit management, wherein said method comprises the steps of:
entering a client's order information comprising products and quantities ordered by said client into a computer system;
producing a sales order record comprising a sales deposit record and its sales deposit payment terms by said computer system based on said order information;
producing a sales deposit collection record by said computer system based on said sales deposit record and a record of received deposit payment from said client to specify which sales orders said client has paid said deposit for;
producing a sales deposit collection voucher record by said computer system based on said sales deposit collection record;
producing a delivery record as the reference for delivery by said computer system based on said sales order record;
producing a sales invoice record for said client by said computer system based on said delivery record wherein the invoiced amount is equivalent to said payment amount of said delivery record;
producing a sales ledger voucher record by said computer system based on said sales invoice record and said sales deposit collection voucher record;
producing a payment collection record by said computer system based on said received payment record; and
producing an accounts receivable record for cancellation of said sales ledger voucher record by said computer system based on said payment collection record and said sales ledger voucher record.

11. A method of sales deposit management, said method comprises the steps of:
entering a client's order information comprising products and quantities ordered by said client into a computer system;
producing a sales order record comprising a sales deposit record and its sales deposit payment terms by said computer system based on said order information;
producing a sales deposit collection record by said computer system based on said sales deposit record and a record of received deposit payment from said client to specify which sales order(s) said client has paid said deposit for;
producing a sales deposit collection voucher record by said computer system based on said sales deposit collection record;
producing a delivery record as the reference for delivery by said computer system based on said sales order record; and
producing a sales invoice record for said client by said computer system based on said delivery record wherein the invoiced amount is equivalent to said payment amount of said delivery record.

12. The method of claim 11, wherein said order information further comprises product delivery date, said sales order record comprises client invoice number, client title, product name, product unit price & quantity, and delivery date, said sales deposit record comprises sales order number, deposit amount, deposit payment deadline, conversion of deposit into sales revenue, and whether to issue an invoice for a received deposit, said sales deposit collection record comprises client invoice number, payment method, deadline for deposit payment, deposit amount, whether to issue a deposit invoice or the invoice type, tax bracket, and tax rate, and said conversion of deposit into sales revenue comprises conversions based on each delivery proportion or a conversion of the total deposit into sales revenue after all the deliveries.

13. The method of claim 11, wherein after producing said delivery record, further comprises a step of checking automatically if said client has paid said sales deposit before processing delivery by said computer system according to said sales deposit payment terms.

14. The method of claim 11, wherein after producing said sales invoice record, further comprises a step of producing a sales ledger voucher record based on said sales invoice record and said sales deposit collection voucher record.

15. The method of claim 14, wherein said sales ledger voucher record comprises voucher date, account terms of the debit and credit sides, and amounts from both sides.

16. The method of claim 15, wherein said accounts receivable amount in said debit side equals to that of said total delivery amount deducted by said deposit in said sales deposit collection voucher record.

17. The method of claim 14, wherein after producing a sales ledger voucher record, further comprises a step of producing a payment collection record by said computer system based on said received payment record.

18. The method of claim 17, wherein after producing a sales ledger voucher record, further comprises a step of producing a payment collection record by said computer system based on said received payment record, said payment collection record comprising client invoice number, payment method, collection date, and collected amount.

19. The method of claim 17, wherein after producing a payment collection record, further comprises a step of producing an accounts receivable record to cancel out said sales ledger voucher record by said computer system based on said payment collection record and said sales ledger voucher record.

20. The method of claim 19, wherein said accounts receivable record means that said collected amount in said payment collection record canceling out said accounts receivable amount in said sales ledger voucher record.
